(19) United States
(12) Patent Application Publication
(10) Pub. No.: US 2008/0266397 A1
(43) Pub. Date: Oct. 30, 2008

(54) Accident witness

(76) Inventors: Navaratne Dombawela, Royal Palm Beach, FL (US); Larissa Dombawela, Royal Palm Beach, FL (US); Ethian Dombawela, Dollard des Ormeaux (CA); Genevieve Dombawela, Dollard des Ormeaux (CA)

Correspondence Address: Navaratne Dombawela, 151 Fernwood Crescent, Royal Palm Beach, FL, 33411, US

(21) Appl. No.: 12/081,244

(22) Filed: Apr. 11, 2008

Related U.S. Application Data
(60) Provisional application No. 60/926,147, filed on Apr. 25, 2007.

(51) Int. Cl. H04N 7/18

(52) U.S. Cl. 348/149; 348/E07.085

(57) ABSTRACT

The unit is an apparatus that can capture the surroundings of a motor vehicle while travelling on the motorways or while parked unattended and allows the owner to remotely access & control the unit and retrieve the captured data if necessary via the internet. The unit also has the capability to surf the internet, receive and send email, play audio/video data and exchange data with external sources either through USB connections or wirelessly via the internet.

This application claims benefit of my provisional Application No. 60/926,147 dated Apr. 25, 2007

### TECHNICAL FIELD OF THE INVENTION

The present invention relates to Audio/Video Monitoring & Recording of vehicle accidents while travelling on motorways as well as Remote Mobile Area Surveillance.

### BACKGROUND OF THE INVENTION

I was involved in an accident where both parties were at fault but due to lack of any other witnesses; I was found solely responsible for the accident. This incident inspired me to assemble a dependable, always available electronic apparatus which can produce clear cut evidence involving motorway accidents/incidents when required. To be able to produce evidence of an accident, all the surrounding area of the vehicle and the relative actions of the nearby vehicles must be captured and this requires the front, back and side view of the vehicle to be continuously monitored. Sometime back one of my brand new cars was also vandalized while parked outside unattended and so I was determined to include remote operation and monitoring capability while unattended into the unit as well which will allow the unit to act also as a mobile remote area surveillance apparatus for security/investigative purposes.

### BRIEF SUMMARY OF THE INVENTION

Captures and records Vehicles surroundings while travelling on motorways or while parked and can send an electronic alert to the owner in the event of an incident

Allows remote access and control of the unit via the internet for area surveillance including data download

Provides entertainment concurrently while recording data

Allows concurrent wireless internet access, surfing the World Wide Web and send and receive electronic messages

### BRIEF DESCRIPTION OF THE DRAWINGS

FIG—1—Camera Assembly

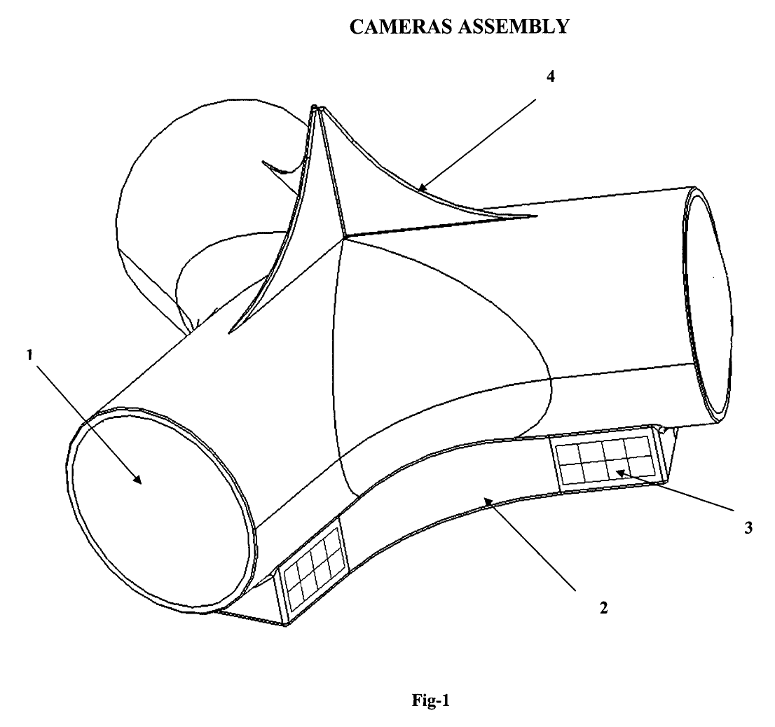

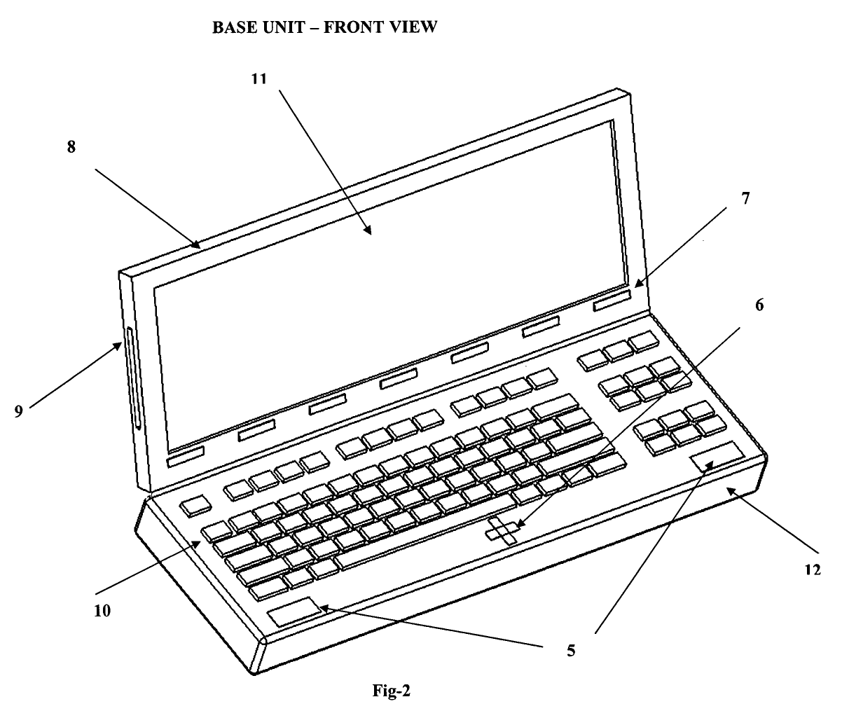

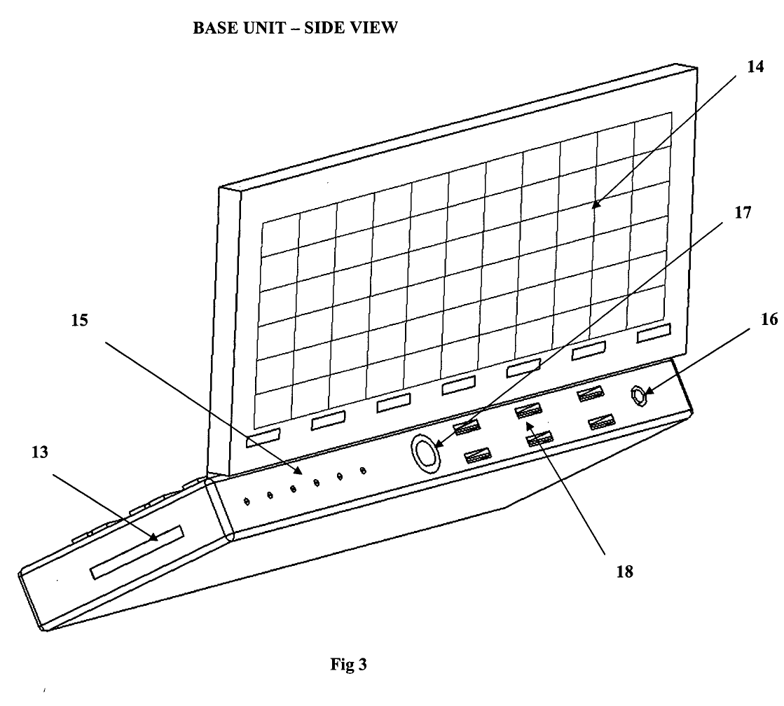

The Camera Assembly consists of three wide angle adjustable digital video cameras 1, mounted on a camera housing 2. The cameras can be arranged so as to cover the field of view as required. The camera housing 2 contains camera controls, built in microphone, a programmable electronic G-force sensor for impact/movement detect, a rechargeable battery and a wireless transmitter/receiver. The solar cell assembly 3 is also housed in the camera housing 2, and is used to charge the battery when needed. The wireless antennas 4, is used to transmit/receive data between the Camera Assembly shown in FIG—1 and the Base Unit shown in FIG. 2.

FIG—2—Base Unit Frontal View

The Base Unit shown in FIG—2 consists of a video monitor 8 connected to a key board housing 12. The key board housing 12 includes a full function computer keyboard 10, navigation keys 6 and integrated speakers 5. The video monitor 8 houses the video display screen 11, camera control buttons 7 and the wireless antenna 9 for data receives and transfers.

FIG—3—Base Unit Side View

The USB ports 18, the S-video port 17 and the component input/output jacks 15 are located in the back of the key board housing 12. These are for communicating with external devices. The solar cell array assembly 14 is mounted on the video monitor 8 while the built in DVD/CD recorder/player 13, 12VDC power input port 16, are housed in the key board housing 12. The rechargeable battery, wireless receiver and the electronic hardware are located inside the key board housing 12.

### DESCRIPTION OF THE PREFERRED EMBODIMENT

The Accident Witness consists of:

1. 3 wide angle, night vision capable, weather proof, adjustable, wireless, high resolution digital color video cameras 1, mounted on a camera housing 2, housing a rechargeable battery, a built in microphone and a wireless transmitter/receiver. These cameras can be operated from battery power, from the motor vehicle 12VDC outlet or from the house hold current. The camera housing 2 also contains an array of solar cells 3 to recharge the battery. The battery can also be recharged with the car 12VDC outlet or the household current. The cameras 1 when so positioned, cover a full field of view around the vehicle. The camera housing 2 includes backup camera switches. The video cameras 1 capture the images within the field of view and transfer the video data via wireless digital signals to the main key board housing 12. The Camera Assembly shown in FIG—1 can be mounted on the roof of the vehicle, on the dashboard or can be integrated into the vehicle structure. The wireless Camera Assembly shown in FIG—1 can be used outside the vehicle for capturing and transmitting data to the Base Unit shown in FIG—2.

2. A Base Unit shown in FIG—2, containing a full function keyboard 10, a video display screen 11, built in speakers 5, 12 VDC power inlet 16, component video input output jacks 15, S-video port 17 and USB ports 18. The keyboard housing 12 houses a rechargeable battery, a built-in wireless transmitter/receiver, a hard disk for data storage, a Broadband Access Device to connect to a high speed wireless Broadband network and has electronic hardware/software Inco-operated into the unit to do the following functions
Process the video images captured by the cameras and store the data on the hard disk while displaying the images simultaneously on the video screen. The video images from all the cameras can be displayed simultaneously on a split screen on the video display screen 11, cycle the camera images from a preselected combination of cameras 1 at pre determined intervals.
Allow remote viewing, control of the apparatus and accessing of the video/audio data captured by the cameras 1 via the internet using the Broadband Access Device
Upload the captured data and any stored data to a remote site via the internet
Access the World Wide Web pages that may contain text, images, videos, and other multimedia and navigate between web pages and web sites for information and/or entertainment
Send and receive electronic messages via the Internet
Play DVD's and CD's using the built in DVD/CD recorder/player 13.
Play electronic games
Transfer the data between the internal hard disk, DVD/CD recorder/player 13, and external electronic devices.
Interface with other external electronic devices
Record and reproduce audio data captured by the microphone located in the Camera Housing 2, via the built-in speakers 5.

The Base Unit shown in FIG—2 also includes an array of solar cells 14 to recharge the battery. The Base Unit shown in FIG—2 can be operated from the installed battery power, from the vehicle 12VDC outlet or from the house hold current. The battery can also be recharged with the vehicle 12VDC outlet or the household current. Camera controls 7 are built into the video monitor 8. Cameras can also be controlled by entering commands via the keyboard 10. The system can be operated and controlled via the internet. The video monitor 8 and the keyboard housing 12 can be integrated individually into the vehicle architecture if necessary.

1. A multipurpose, weather proof, night vision capable, Electronic Apparatus that can be mounted on a vehicle to Video Monitor, Record and Display the vehicle surroundings, relative speed, direction of travel and the highway conditions including the location and movement of adjacent vehicles so as to provide collaborating evidence in the event of an accident while travelling on motorways.

2. The Apparatus of claim 1 that can also capture and Video Record any break-ins, vandalism, hit and run cases or other incidents that may cause damage to the vehicle when the vehicle is parked unattended and send an electronic alert to the vehicle owner.

3. The Apparatus of claim 2 that also allows the owner to remotely access the cameras and recording devices of the apparatus via the Internet to survey & monitor the surroundings around the vehicle or use it as an area surveillance apparatus for security, investigative purposes.

4. The Apparatus of claim 3 that can also assist the driver during difficult maneuvering operations such as during reversing in bad light, parking in tight spaces etc.

5. The Apparatus of claim 4 that also provides concurrent entertainment activity such as play electronic games, show video movies, play recorded music while simultaneously recording the data captured by the video cameras.

6. The Apparatus of claim 5 that also can Access/Download World Wide Web pages, send and receive electronic messages while simultaneously recording the captured Video/Audio data.

7. The Apparatus of claim 6 that can also Exchange data between the unit's hard disk, built in DVD/CD recorder/player or an external electronic device via USB connections or via wireless internet.

8. The Apparatus of claim 7 which also has provisions to integrate a GPS navigator into the unit utilizing the electronic hardware and software already in the system
